(19) United States
(12) Patent Application Publication
(10) Pub. No.: US 2026/0358786 A1
(43) Pub. Date: Nov. 12, 2026

(54) MOTOR CONTROLLER AND METHOD FOR ESTIMATING A MOTOR SHAFT ANGLE AND/OR A MOTOR SHAFT ROTATION SPEED OF A MOTOR

(71) Applicant: Infineon Technologies AG, Neubiberg (DE)

(72) Inventors: Mihail Jefremow, Augsburg (DE); Jürgen Schäfer, Oberhaching (DE); Arndt Voigtländer, Antdorf (DE)

(21) Appl. No.: 19/666,492

(22) Filed: May 4, 2026

(30) Foreign Application Priority Data
May 8, 2025 (DE) 10 2025 117 739.2

(51) Int. Cl. G05B 19/4063; G01B 7/30; G01D 5/20; G01P 7/00; H02K 24/00; H02P 23/00; H02P 23/12; H02P 23/14

(52) U.S. Cl. CPC G05B 19/4063; G01B 7/30; G01D 5/20; G01P 7/00; H02K 24/00; H02P 23/0018; H02P 23/12; H02P 23/14; G05B 2219/32335; G05B 2219/37473; G05B 2219/50193

(57) ABSTRACT

According to various embodiments, a motor controller is described comprising an estimation circuit configured to perform motor shaft angle estimation using a feedback loop which includes feedback of an angle estimation error signal generated by the estimation circuit and an anomaly detector comprising an autoencoder trained on sections of angle estimation error signals, wherein the anomaly detector is configured to supply a section of the angle estimation error signal generated by the estimation circuit to the autoencoder, determine a reconstruction error of the autoencoder for the section of the angle estimation error signal and to perform a safety action depending on a value derived from the reconstruction error.

### REFERENCE TO RELATED APPLICATION

This Application claims the benefit of German Application number 10 2025 117 739.2, filed on May 8, 2025, the contents of which are hereby incorporated by reference in their entirety.

### TECHNICAL FIELD

The present disclosure relates to motor controllers and methods for estimating a motor shaft angle and/or a motor shaft rotation speed of a motor.

### BACKGROUND

In electric motor control, accurate estimation of motor position and speed is crucial for ensuring optimal performance and safety. Estimation of motor position and speed is typically done based on signals provided by motor sensors such as resolvers, which are robust electromechanical devices that provide precise angular position feedback, making them ideal for harsh environments and high-reliability applications. Still, errors thus as short circuits or disconnections may occur which leads to a malfunction of position or speed and which may by unacceptable depending on the safety requirements. Accordingly, approaches for accurate and safe motor position and/or speed estimation are desirable.

According to various embodiments, a motor controller is provided comprising an estimation circuit configured to perform motor shaft angle estimation using a feedback loop which includes feedback of an angle estimation error signal generated by the estimation circuit and an anomaly detector comprising an autoencoder trained on sections of angle estimation error signals, wherein the anomaly detector is configured to supply a section of the angle estimation error signal generated by the estimation circuit to the autoencoder, determine a reconstruction error of the autoencoder for the section of the angle estimation error signal and to perform a safety action depending on a value derived from the reconstruction error.

According to a further embodiment, a method for estimating a motor shaft angle and/or a motor shaft rotation speed of a motor according to the above motor controller is provided.

### BRIEF DESCRIPTION OF THE DRAWINGS

In the drawings, similar reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a motor control arrangement according to an embodiment.

FIG. 2 shows a resolver-to-digital converter according to an embodiment.

FIG. 3 shows a motor control arrangement according to an embodiment.

FIG. 4 shows an autoencoder network according to an embodiment.

FIG. 5 illustrates an expected signal behavior.

FIG. 6 illustrates signals in a nominal case.

FIG. 7 illustrates signals in a case where there is a short of a resolver output.

FIG. 8 illustrates signals in a case where an input has been disconnected.

FIG. 9 illustrates signals in a case where a resolver output signal is rectangular.

FIG. 10 illustrates signals in a case where resolver output signals have reduced amplitude.

FIG. 11 illustrates signals in a case where a resolver output signals have reduced amplitude using a sliding window approach.

FIG. 12 shows a motor controller according to an embodiment.

FIG. 13 shows a flow diagram illustrating a method for estimating a motor shaft angle and/or a motor shaft rotation speed of a motor.

### DESCRIPTION

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

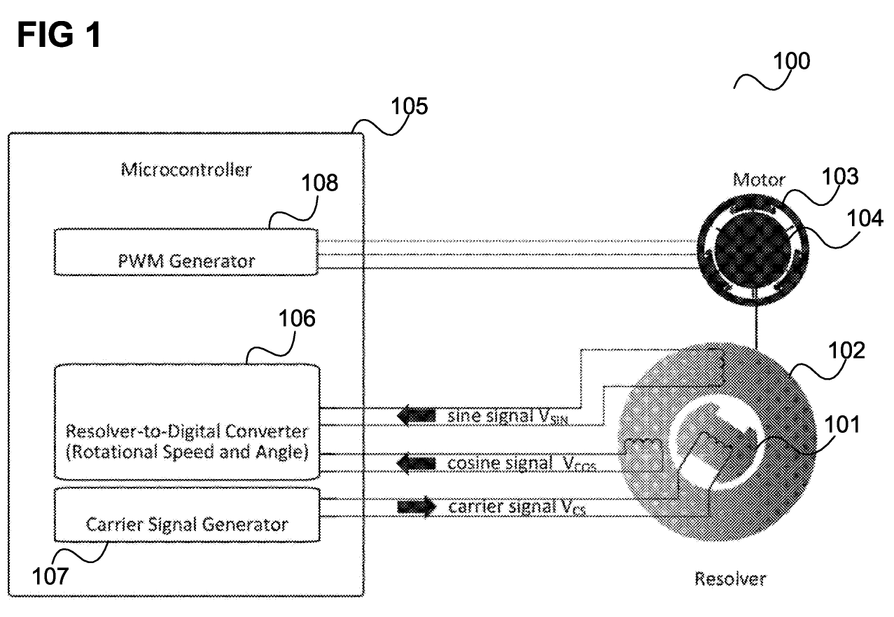

FIG. 1 shows a motor control arrangement 100 according to an embodiment.

The rotor 101 of a resolver 102 is attached to a motor shaft driven by a motor 103 (e.g. a permanent magnet synchronous motor (PMSM)) such that the angular position (i.e. angle) and the rotational speed of the resolver rotor 101 corresponds to the motor rotational speed and the angular position of the motor rotor 104.

The motor 103 is controlled by a microcontroller 105 (operating as motor controller) comprising a resolver-to-digital converter 106 (receiving output signals from the resolver 102), a carrier signal generator 107 (supplying the resolver rotor 101 with a carrier signal) and a PWM (pulse width modulation) generator 108.

During operation, the carrier signal generator 107 generates a carrier signal for output to the resolver 102. The resolver 102 is an electrical transformer that measures a rotational angle of the motor shaft driven by the motor 103. The resolver 102 has three coil windings: a primary winding supplied with the carrier signal and two secondary windings which output measurement signals, referred to as a sine signal and a cosine signal (although strictly speaking, they are a carrier with a sine envelope and a cosine envelope, respectively). The secondary windings are mounted 90° apart from each other in relation to the motor shaft. The primary winding is mounted on the resolver rotor 101 (and thus on the motor shaft) and in operation is excited by the carrier signal which is applied thereto. As the motor shaft rotates, the excited primary winding induces voltages in the secondary windings varying sinusoidally, thereby generating the sine signal and the cosine signal. The sine and the cosine signal are amplitude-modulated versions of the carrier signal with (ideally) a sine waveform and a cosine waveform as envelope, respectively. The resolver-to-digital converter 106 uses the sine signal and the cosine signal to determine an angular position θ of the motor shaft (according to sine θ/cosine θ=tangent θ) and, by considering the change of angular position over time, a rotational speed of the motor shaft.

The microcontroller 105 controls the motor via PWM, i.e. by controlling the PWM generator 108 to output PWM signals, e.g. according to a desired acceleration and supplies the PWM signals to the motor (e.g. via an eGTM (Enhanced Gate Driver Module) to a IGBT (Insulated Gate Bipolar Transistor) hybrid pack of the motor) to control the motor accordingly.

The microcontroller 105 may for example perform space vector PWM. This may include field-oriented control (FOC) using measurements of the average current through the motor windings as input (in addition to the angle and speed information provided by the resolver-to-digital converter 106.

So, the motor control arrangement 100 forms a control loop for controlling the motor according to closed-loop control where a control signal (PWM signals for the three phases of the motor) is determined by the microcontroller (i.e. motor controller) based on measurements (sine signal and cosine signal and possibly average current measurements) and thus adapted to a feedback path (providing the measurements). In the following, an example for the structure and functionality of the resolver-to-digital converter 106 is described.

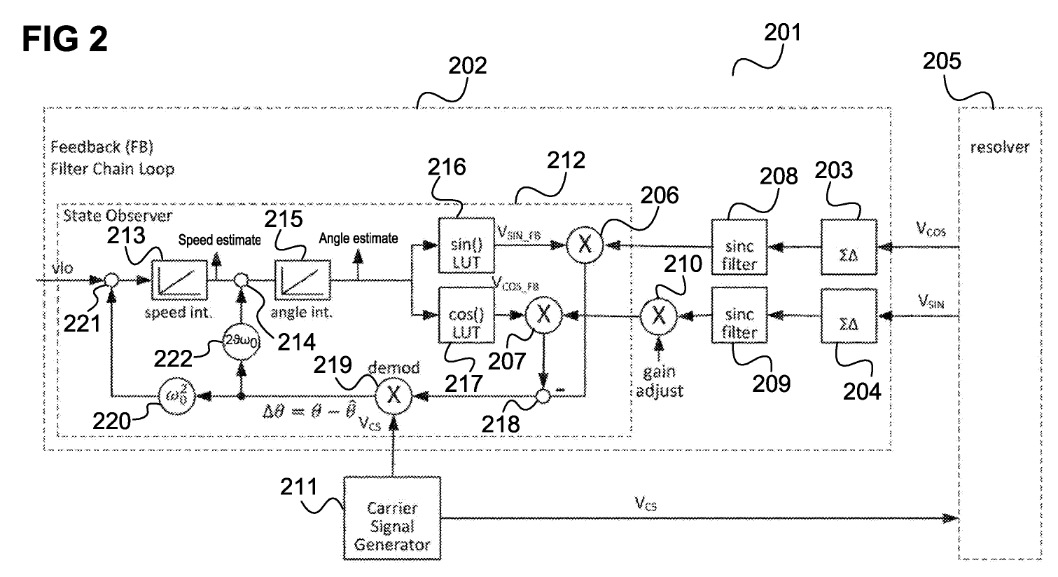

FIG. 2 shows a resolver-to-digital converter 201 according to an embodiment.

The resolver-to-digital converter 201 may for example be implemented in software on a CPU of the microcontroller 105 or on a digital signal processor of the microcontroller 105, e.g. a CDSP (Converter Digital Signal Processor).

The resolver-to-digital converter 201 comprises a feedback (FB) filter chain loop 202 which provides a speed estimate and an angle estimate and optionally a post-processor which performs post-processing before outputting the angle estimate and speed estimate (e.g. to a CPU performing the PWM control as described above with reference to FIG. 1).

The FB filter chain loop 202 comprises a pair of analog-to-digital converters 203, 204 (e.g. delta-sigma analog-to-digital converters (DS-ADCs)) which provide digitized versions of the sine and cosine signal (i.e. time series of, e.g. 16-bit, samples of the since and cosine signal, respectively) provided by the resolver 205 (corresponding to the resolver 102).

Optionally, the digitized cosine signal may be processed by a first sinc filter 208 before supplying it to a first mixer 206 and the digitized sine signal may be processed by a second sinc filter 209 and a gain adjuster (multiplier) 210 by a certain gain before supplying it to a second mixer 207.

So, the pair of DS-ADCs are configured to convert a pair of input sine and cosine signals VSIN, VCOS received from the resolver 205 as described above with reference to FIG. 1 from analog to digital. As mentioned above, the pair of input sine and cosine signals VSIN, VCOS are amplitude-modulated (AM) versions of a carrier signal VCS supplied by a carrier signal generator 211 which represent the rotation angle θ of the motor shaft. These input signals may be noisy. In particular, they are supposed to be phase shifted by 90 degrees with respect to each other, but due to the noise, they may not be.

The (optional) pair of sinc filters 208, 209 is configured to filter the pair of digital input sine and cosine signals VSIN, VCOS . A sinc filter is a type of low pass filter that removes high frequency components above a given cutoff frequency.

The first mixer 206 and the second mixer 207 are part of a state observer (e.g. a Luenberger observer) 212 of the FB filter chain loop 202. The state observer 212 is configured to estimate the rotation speed and the angular position (i.e. rotation angle) of the motor shaft from the digitized (and possibly filtered and gain-adjusted) sine signal and cosine signal supplied to it.

The state observer 212 comprises a rotation speed integrator 213 (configured to integrate a rotational acceleration to provide a rotational speed estimate), a first adder 214, a rotation angle integrator 215 (configured to integrate a rotational speed to provide an angle estimate), a sine look-up-table (LUT) 216 and a cosine LUT 217, i.e. a look-up table containing sine values (sine signal value look-up table) and a look-up table containing cosine signal values (cosine signal value look-up table), which may also be combined into one look-up table.

The rotation speed integrator 213 is configured to integrate an estimated rotation angle error signal Δθ (indicating an angle estimation error, also denoted for short as angle error in the following) of the motor shaft, and to output the rotation speed estimate. The rotation speed integrator 213 integrates its input over a carrier period to generate an envelope signal used for subsequent processing.

The first adder 214 is coupled between the rotation speed integrator 213 and the rotation angle integrator 215. It is configured to add the estimated rotation speed to a dampened version of 2ϑω0Δθ the estimated rotation angle error signal Δθ.

The rotation angle integrator 215 is configured to integrate the offset version of the estimated rotation speed provided by the first adder 214 and output the estimated rotation angle of the motor shaft.

The sine LUT 216 is configured to determine a feedback sine signal VSIN_FB according to the estimated rotation angle and the cosine LUT 217 is configured to determine a feedback cosine signal VCOS_FB according to the estimated rotation angle. The FB sine signal is mixed with the input cosine signal by the first mixer 206 the FB cosine signal is mixed with the input sine signal by the second mixer 207, to generate, by subtracting the outputs of the two mixers 206, 207 from each other by a subtractor 218, a (difference) signal which represents the estimated rotation angle error signal Δθ which can be seen as a difference between state observer’s estimate and the actual motor shaft angular position.

A demodulator 219 then demodulates the difference signal by multiplying it with the carrier signal VCS to output a demodulated version of the difference signal, i.e. the estimated rotational angle error signal Δθ. (It should be noted in this context that a small angle error Δθ can be approximated by sine(Δθ), which is a component resulting from the demodulation, and that higher frequency components are filtered out by the integrators 213 and 215).

The estimated rotational angle error signal is then gain-adjusted by two constants: A first multiplier 220 multiplies the estimated rotational angle error signal Δθ by ωo2 to output a gain-adjusted version of the rotational speed error signal, which a second adder 221 combines with a measured acceleration signal vlo to output the input to the rotational speed integrator 213, thereby closing the loop and a second multiplier 222 multiplies the estimated rotational angle error signal Δθ by a damping constant 2ϑω0 to generate the dampened version 2ϑω0Δθ of the estimated rotation angle error signal Δθ.

For example, the resolver-to-digital converter elements to the left of the sinc filters 208, 209 are implemented in software, with the sinc filters 208, 209 and DS-ADCs 203, 204 implemented in hardware.

In safety-related applications (such as applications needing to fulfil a high Automotive Safety Integrity Level such as ASIL-D), it should be possible that a failure of the resolver-to-digital converter 106 can be avoided or at least detected. One approach is to provide its functionality two times, in a redundant manner, in the microcontroller 105. For example, the microcontroller 105 may implement two state observers 212 (downstream from ADCs 203, 204, sinc filters 208, 209 and gain adjustment 210) and which operate in parallel and generate each a position and a speed estimate and the microcontroller 105 further implements a comparator which compares the estimation results of the two state observers 212 and performs a safety action, e.g. triggers an alarm in case of a mismatch. However, if, for example, one of the ADCs 203, 204 provides a signal which is always zero then both state observers 212 receive the same input signals and hence generate the same result but still, the position and speed estimation does not work correctly.

To enable detection of such kind of failures, according to various embodiments, a motor shaft angle and/or motor shaft rotation speed estimation approach is described which includes forwarding paths for the input signals which are compared to signals generated by the estimation circuit, as described in more detail in the following.

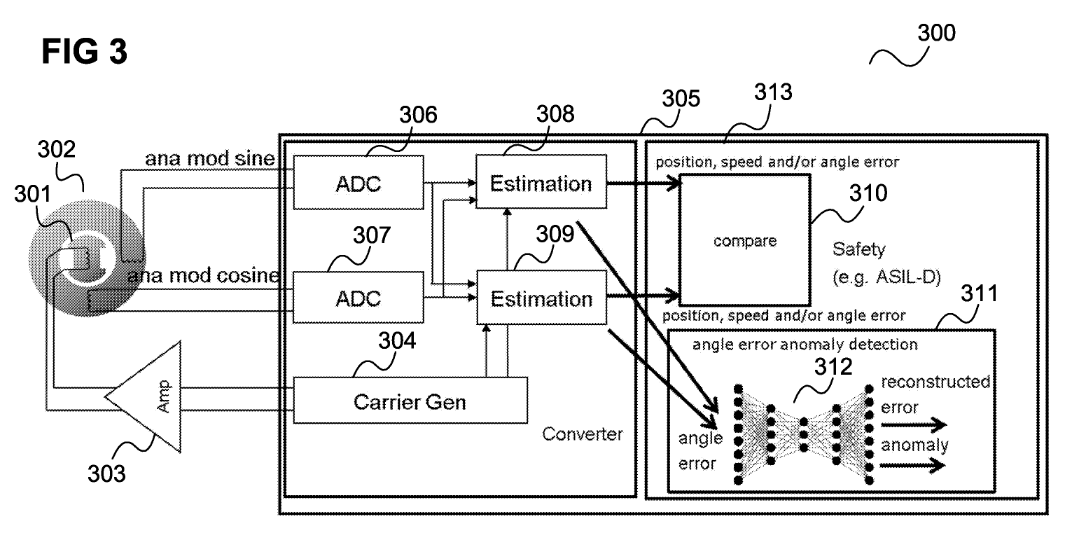

FIG. 3 shows a motor control arrangement 300 according to an embodiment.

Like in the motor control arrangement 100, the rotor 301 of a resolver 302 is attached to a motor shaft driven by a motor (not shown in FIG. 3, the PWM control is also not shown in FIG. 3) such that the angular position (i.e. angle) and the rotational speed of the resolver rotor 301 corresponds to the motor rotational speed and the angular position of the motor rotor.

A microcontroller 305 comprises two analog-to-digital converters (ADCs) 306, 307 corresponding to the ADCs 203, 204 which provide digitized versions of the signals (referred to as resolver output sine signal or “ana mod sine” and resolver output cosine signal or “ana mod cosine”, respectively) output by the resolver 302 (which the resolver generates by modulating a carrier signal supplied to the rotor 301 by a carrier generator 304 and an amplifier 303) as described above.

The microcontroller 305 then comprises two estimation paths, in the present example implemented by a first estimation circuit 308 and a second estimation circuit 309, respectively. Each estimation circuit 308, 309 implements a state observer 212 (e.g. preceded by sinc filters 208, 209 and the gain adjuster 210) as described with reference to FIG. 2.

Accordingly, both estimation circuits 308, 309 generate a speed estimate signal (i.e. a time series of speed estimates), an angle estimate (including a time series of angle estimates) and a rotational angle error signal Δθ (including a time series of angle error estimates). Each of these time series includes a respective signal value (speed estimate, angle estimate and rotational angle error, respectively) for each of a sequence of estimation times (e.g. sampling times).

The microcontroller 305 includes a comparator 310 which compares the speed estimates generated by the first estimation circuit 308 with those generated by the second estimation circuit 309, the angle error estimates generated by the first estimation circuit 308 with those generated by the second estimation circuit 309 and/or the angle errors generated by the first estimation circuit 308 with those generated by the second estimation circuit 309. In case of a detection of a mismatch, it triggers a safety action.

So, the microcontroller 305 includes, for safety (e.g. to fulfill ASIL-D requirements), an approach where it provides the estimation functionality two times, in a redundant manner: the estimation circuits 308 and 309 operate in parallel and the comparator 310 compares their results and performs a safety action in case of a mismatch. This increases safety. However, if, for example, the input to the estimation is corrupted, e.g. one of the ADCs 306, 307 provides a signal which is always zero, then both estimation circuits 308, 309 receive the same input signals and hence generate the same result but still, the position and speed estimation does not work correctly.

To cover such a kind of malfunction, the microcontroller 305 further includes an angle error anomaly detector 311. The anomaly detector 311 is for example, together with the comparator 310, part of a safety circuit 313. The angle error anomaly detector 311 implements a neural network with an autoencoder architecture, i.e. an autoencoder 312, to generate reconstructions of angle errors input to it (from one of the estimation circuits 308, 309). The angle error anomaly detector 311 then compares the reconstructions with the original angle errors (i.e. which have been reconstructed) and considers a large reconstruction error (or multiple large reconstruction errors) as an indication of an anomaly, i.e. a malfunction, and performs a safety action, e.g. trigger an alarm.

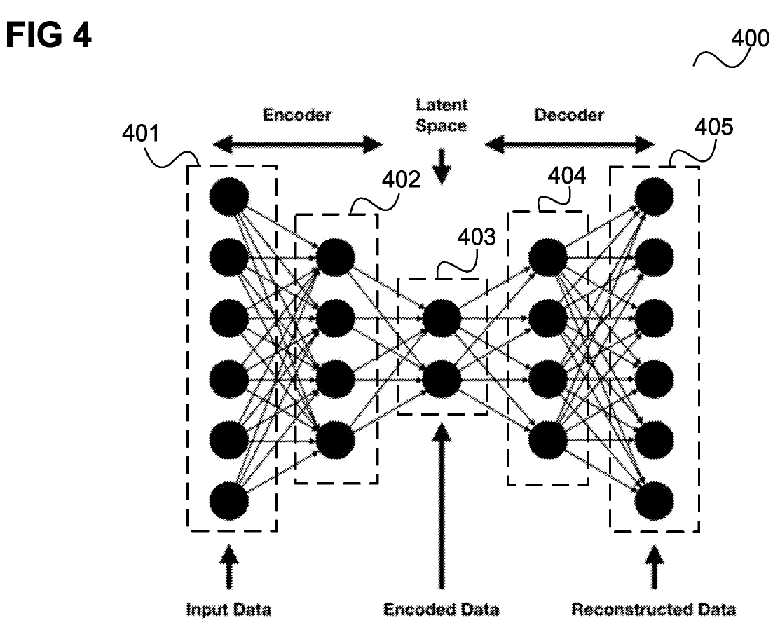

FIG. 4 shows an autoencoder network 400 which is for example used as the autoencoder 312.

The autoencoder 400 includes an input layer 401 comprised of nodes (shown as circles) interconnected (e.g., in this example fully connected) with nodes forming a first hidden layer 402.

The input layer 401 includes nodes (e.g., 32 nodes) that receive input data, wherein each node receives a value of a section (of a length corresponding to the number of the nodes of the input layer) of a time series. For example, the topmost node gets a current value of the time series, the second node from the top gets the previous value of the time series and so on such that, for each estimation time (i.e. each estimation cycle performed by the estimation circuits 308, 309) the most recent time series values (in a certain observation window, e.g. of length 32) are fed to the machine learning model 400. When used as the autoencoder 312, each value fed to the autoencoder is an angle error for the respective estimation time. Accordingly, for example, the topmost node gets the current angle error, i.e. the angle error that the estimation circuits 308, 309 have determined last. It should be noted that without malfunction the estimation circuits 308, 309 determine the same angle errors so the angle errors can be taken from either of them.

The machine learning model 400 has an autoencoder structure (i.e. an autoencoder architecture) where in this example, the encoder part has only a single hidden layer 402, i.e. the output of the hidden layer 402 is a latent representation 403 of the input data in a latent space. The latent representation 403 is compressed with respect to the input data (i.e. is a vector of less values (e.g. 16 values) than the (e.g. 32) values of the input data) and can be seen as encoded data (or encodings of the input).

It should be noted that 32 input values are only an example, and more input values can be used, e.g. 201 input values. The latent representation 403 may in such a case have for example 50 or 100 values.

In the example of FIG. 4, the decoder also only comprises a single hidden layer (second hidden layer 404) and an output layer 405 (like in the encoder part fully connected). The second hidden layer 404 and the output layer 405 decode encoded data.

The autoencoder may also have more than one hidden layer on the encoder side and/or the decoder side.

The autoencoder is trained to reproduce the input data, i.e. the output data should match the input data. Training examples can be generated by taking time series of angle errors that the estimation circuits 308, 309 generate when no malfunctions occur. The autoencoder can then be trained by feeding batches of sections of the time series of angle errors (i.e. sections of angle estimation error signals) to the autoencoder, calculating, for each section, a loss between the section and its reconstruction output by the autoencoder, generating a total loss by summing over the losses and adjusting the autoencoder (i.e. its weights) to reduce the loss (by backpropagation of the total loss)

In operation for anomaly detection, the value that the decoder of the autoencoder 312 provides for the current input value is used (i.e. e.g. the topmost value if the same order of input nodes and output nodes is used, e.g. from top to bottom). So, in the example of FIG. 3, the autoencoder 312 provides a vector of output values (reconstructed angle errors) and the one corresponding to the most recent value in the input vector (e.g. the angle error the autoencoder 312 outputs at the topmost output node) is used as reconstruction for the current anomaly detection time.

It should be noted that the anomaly detector 311 may perform the encoding and reconstruction for each of a sequence of anomaly detection times which may correspond to the estimation cycles of the estimation circuits 308, 309 (i.e. to each iteration of the angle estimation) but may also be a subset thereof, i.e. the anomaly detector 311 may operate on angle estimation errors generated for anomaly detection times corresponding to a downsampling of the angle estimation errors generated at all estimation times.

For each anomaly detection time, the anomaly detector 311 compares the angle value for the anomaly detection time with its reconstruction. It may use this individual reconstruction error for deciding whether to perform a safety action but it may also aggregate reconstruction errors. For example, the anomaly detector 311 performs a comparison of input angle error and reconstructed angle error over multiple time steps (i.e. a certain window of anomaly detection times), i.e. generates a difference (reconstruction error) between input angle error and reconstructed angle error and, if the sum of differences over the window exceeds a threshold, it performs a safety action, e.g. triggers an alarm. In other words, the anomaly detector may include a post-processing of the reconstruction errors by flying integrator (i.e. an integrator accumulating over a sliding window) to detect long time anomalies. This helps detecting anomalies which comprise angle errors which are low but persist over a relatively long time period.

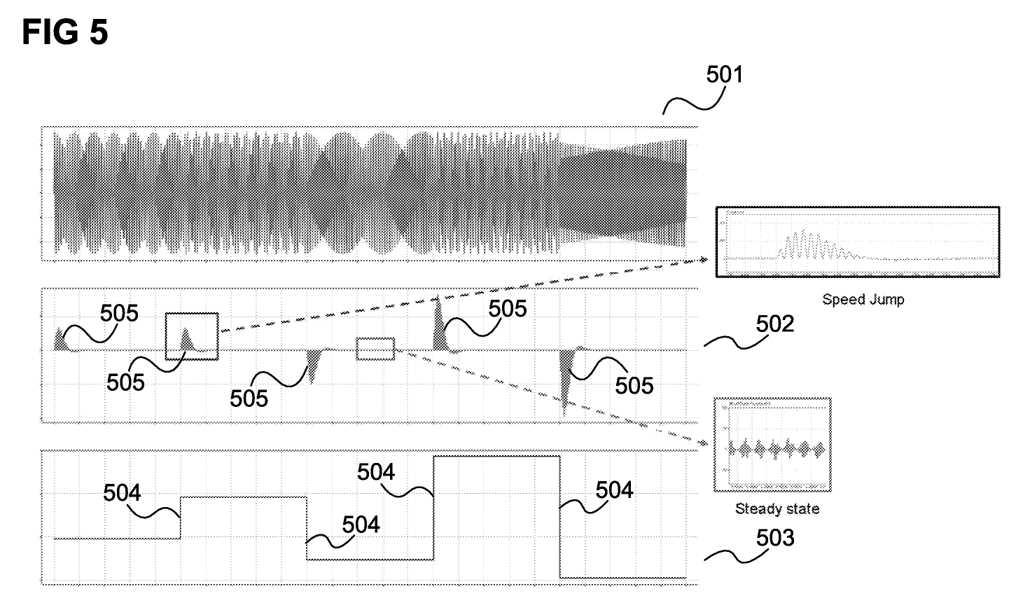

FIG. 5 illustrates the expected signal behavior of the angle error.

A first diagram 501 illustrate the resolver output “sine signal” and resolver output “cosine signal” (i.e. carrier signal with sine envelope and cosine envelope).

A second diagram 502 illustrates the angle errors as determined by the estimation circuits 308, 309.

A third diagram 503 shows the speed of the motor as reference. In this example, there are speed changes 504 certain points in time.

As can be seen, angle error spikes 505 occur when speed changes 504 take place. These then decrease to angle error values near zero of a steady state pattern (with small fluctuations according to the operation of the respective control loop) between the speed changes 504.

By training the autoencoder 312 using time series of angle errors that the estimation circuits 308, 309 generate when no malfunctions occur, the autoencoder learns to correctly such a kind of error signal pattern (i.e. angle error spikes 505 which decrease to the steady state pattern).

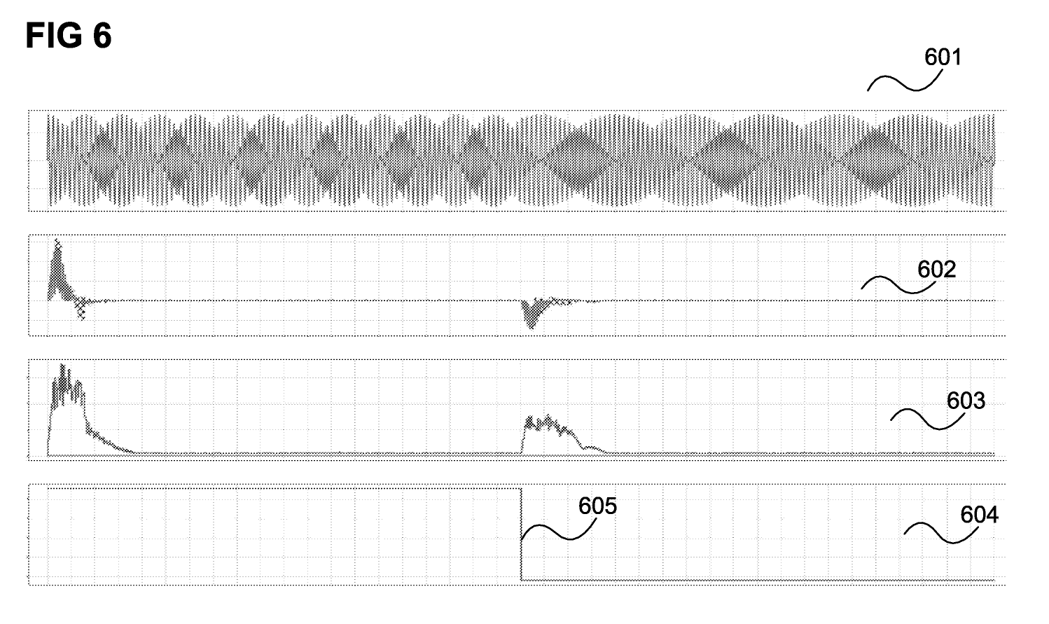

FIG. 6 illustrates signals in a nominal case (i.e. “good” case without malfunction).

A first diagram 601 illustrate the resolver output “sine signal” and resolver output “cosine signal” (i.e. carrier signal with sine envelope and cosine envelope).

A second diagram 602 illustrates the angle errors as determined by the estimation circuits 308, 309 as well as the reconstructions (shown hatched).

A third diagram 603 illustrates the reconstruction errors as well as the value of a flag that the anomaly detector 311 sets when it detects an anomaly. Anomaly detection is in this example based on the reconstruction error of a single time step (i.e. the reconstruction error for a single anomaly detection time is compared with the threshold to determine whether to raise the flag). Since the signals are as they are supposed to be and the reconstruction error is therefore low, the anomaly flag is constant at zero (because the threshold is not exceeded).

A third diagram 604 shows the speed of the motor as reference. In this example, there is a speed change 605 at a certain point in time. This diagram is omitted in the following figures since it stays the same.

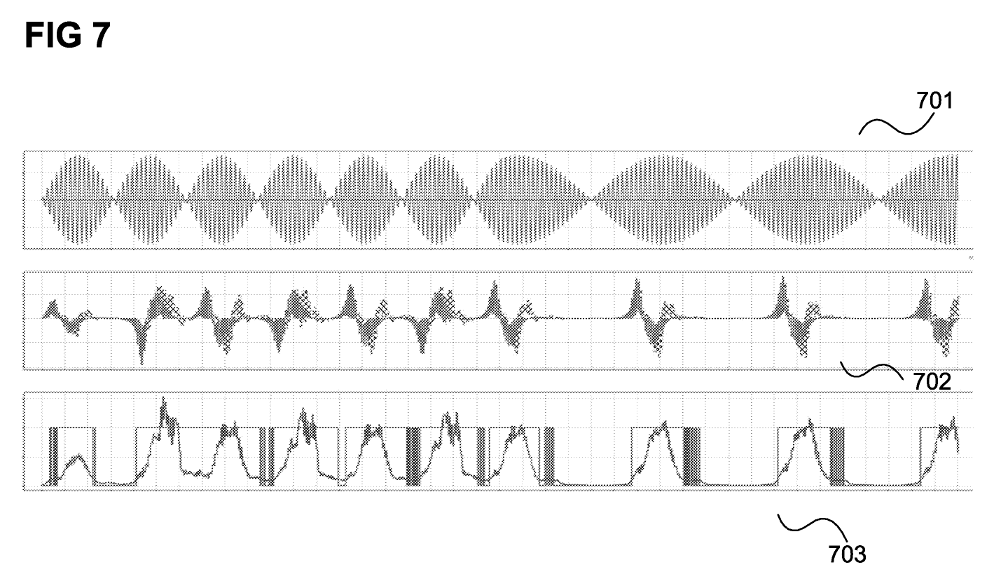

FIG. 7 illustrates signals in a case where there is a short of the resolver output cosine signal.

A first diagram 701 illustrates the resolver output sine signal and resolver output cosine signal (i.e. carrier signal with sine envelope and cosine envelope). The resolver output cosine signal is equal to zero.

A second diagram 702 illustrates the angle errors as determined by the estimation circuits 308, 309 as well as the reconstructions (shown hatched).

A third diagram 703 illustrates the reconstruction errors as well as the value of a flag that the anomaly detector 311 sets when it detects an anomaly. Anomaly detection is in this example based on the reconstruction error of a single time step (i.e. the reconstruction error for a single anomaly detection time is compared with the threshold to determine whether to raise the flag).

As can be seen, the reconstruction error exceeds the threshold for a multiplicity of anomaly detection times (it should be noted that the reconstruction error are stronger scaled than in FIG. 6). Therefore, the anomaly detector 311 raises the flag and detects the malfunction.

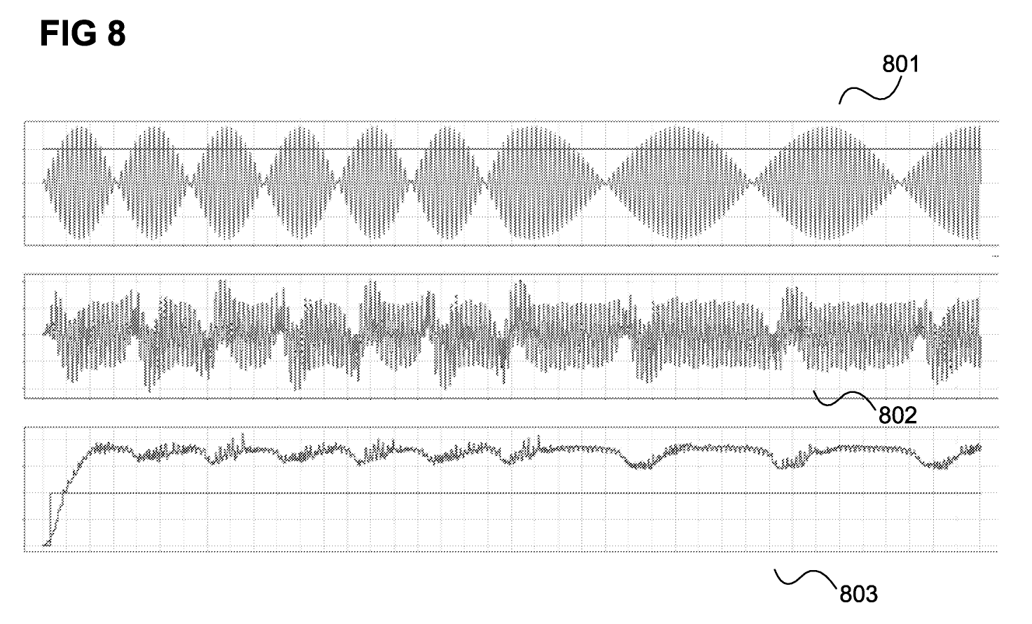

FIG. 8 illustrates signals in a case where the input for the resolver output cosine has been disconnected and the cosine received by the microcontroller is therefore stuck at a fixed voltage.

A first diagram 801 illustrates the resolver output sine signal and resolver output cosine signal (i.e. carrier signal with sine envelope and cosine envelope). The resolver output cosine signal is equal to 3V.

A second diagram 802 illustrates the angle errors as determined by the estimation circuits 308, 309 as well as the reconstructions (shown hatched).

A third diagram 803 illustrates the reconstruction errors as well as the value of a flag that the anomaly detector 311 sets when it detects an anomaly. Anomaly detection is in this example based on the reconstruction error of a single time step (i.e. the reconstruction error for a single anomaly detection time is compared with the threshold to determine whether to raise the flag) .

As can be seen, the reconstruction error exceeds the threshold continuously after a short time. Therefore, the anomaly detector 311 raises the flag and detects the malfunction.

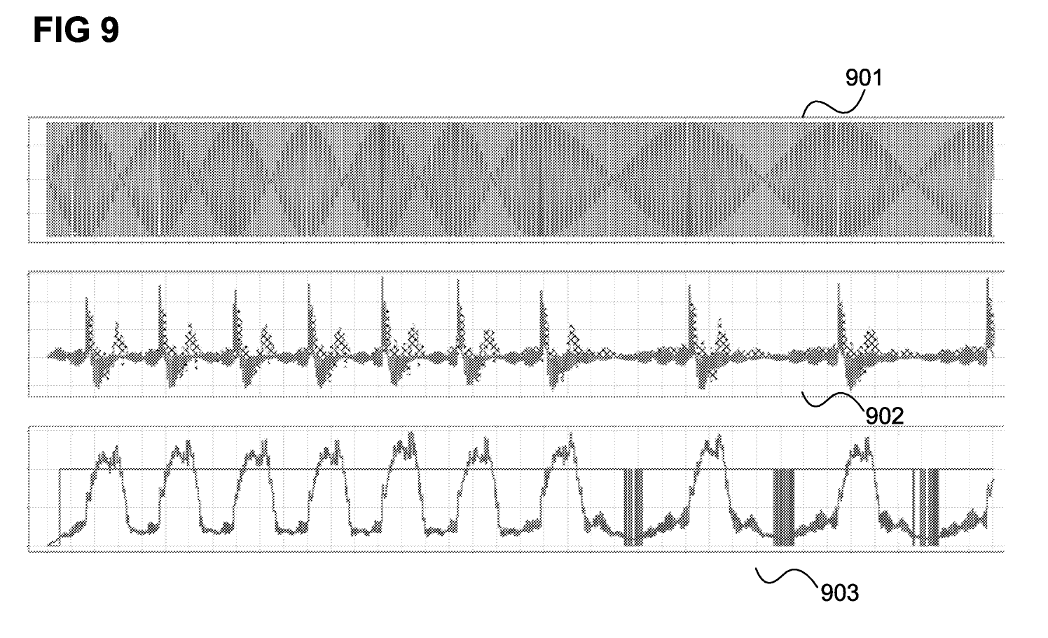

FIG. 9 illustrates signals in a case where the resolver output sine signal is rectangular.

A first diagram 901 illustrates the resolver output sine signal and resolver output cosine signal (i.e. carrier signal with sine envelope and cosine envelope). The resolver output sine signal is rectangular, i.e. the amplitude of the modulated carrier is fixed instead of following a since envelope.

A second diagram 902 illustrates the angle errors as determined by the estimation circuits 308, 309 as well as the reconstructions (shown hatched).

A third diagram 903 illustrates the reconstruction errors as well as the value of a flag that the anomaly detector 311 sets when it detects an anomaly. Anomaly detection is in this example based on the reconstruction error of a single time step (i.e. the reconstruction error for a single anomaly detection time is compared with the threshold to determine whether to raise the flag).

As can be seen, the reconstruction error exceeds the threshold continuously after a short time with only small interruptions. Therefore, the anomaly detector 311 raises the flag and detects the malfunction.

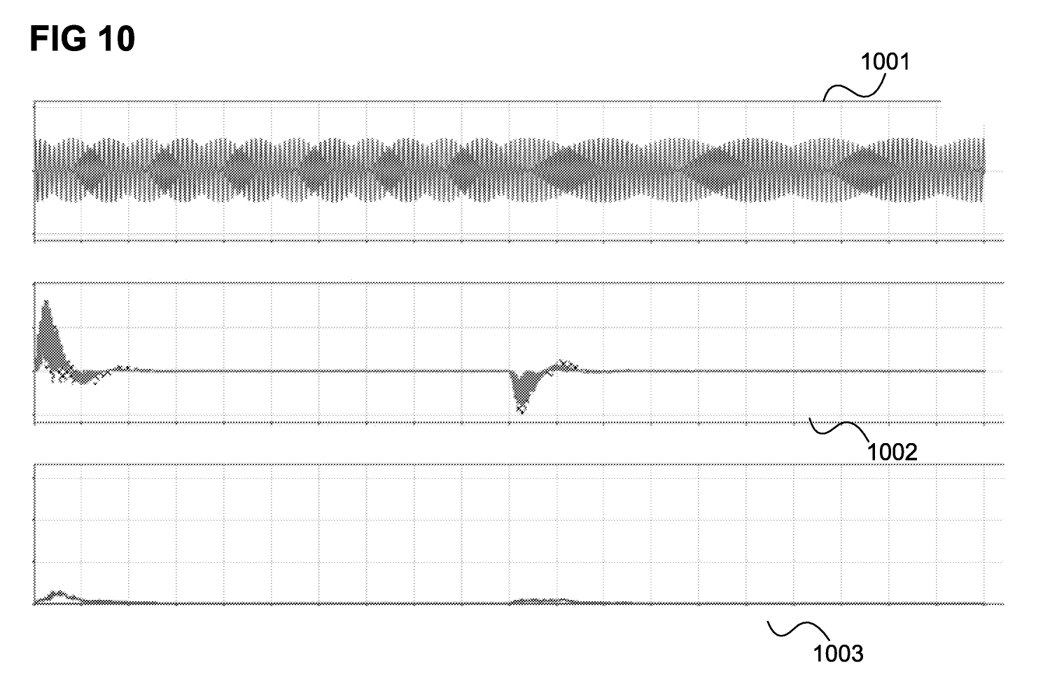

FIG. 10 illustrates signals in a case where the resolver output sine and cosine have reduced amplitude.

A first diagram 1001 illustrates the resolver output sine signal and resolver output cosine signal (i.e. carrier signal with sine envelope and cosine envelope).

A second diagram 1002 illustrates the angle errors as determined by the estimation circuits 308, 309 as well as the reconstructions (shown hatched).

A third diagram 1003 illustrates the reconstruction errors as well as the value of a flag that the anomaly detector 311 sets when it detects an anomaly. Anomaly detection is in this example based on the reconstruction error of a single time step (i.e. the reconstruction error for a single anomaly detection time is compared with the threshold to determine whether to raise the flag) .

As can be seen, the reconstruction error does not exceed the threshold since the angle error signal is scaled with respect to the nominal case and therefore the autoencoder 312 can reconstruct it with a small reconstruction error. Therefore, the anomaly detector 311 is not capable of detecting the malfunction.

To be capable of detecting such kind of malfunction (reduced amplitude), according to various embodiments, rather than performing anomaly detection based on comparison of the reconstruction error with a threshold for a single anomaly detection time, the anomaly detector 311 uses the flying window approach as described above: it detects an anomaly in reaction to the reconstruction errors aggregated over a sliding window (including the current anomaly detection time and a predetermined number of preceding anomaly detection times) exceeds a threshold. The sliding window covers several hundred (e.g. 600) detection times, for example.

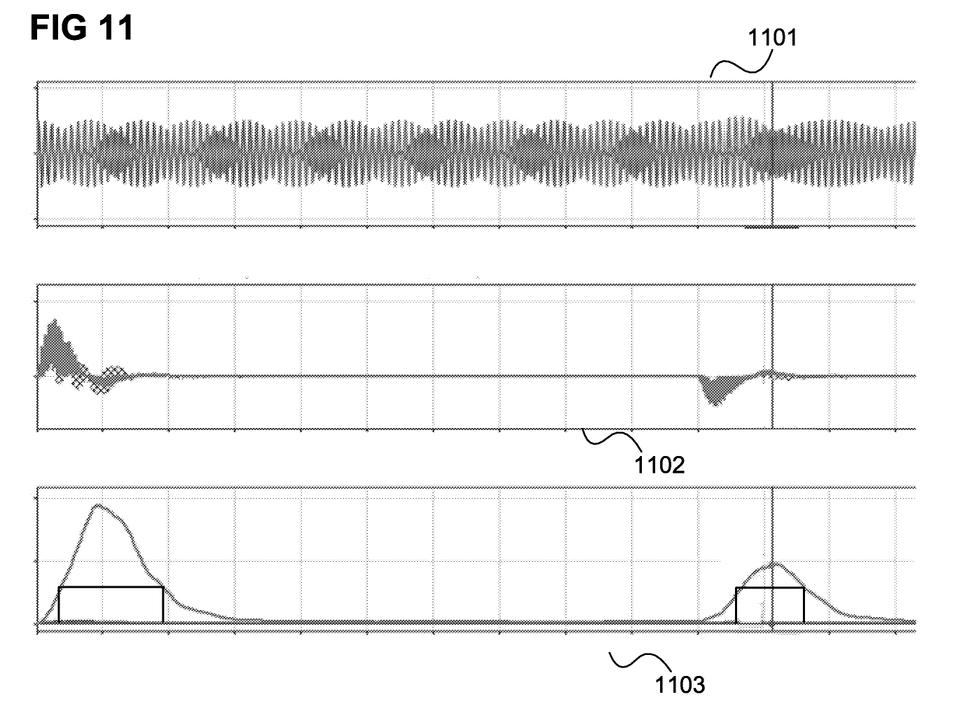

This is illustrated in FIG. 11.

FIG. 11 illustrates signals in a case where the resolver output sine and cosine have reduced amplitude.

As in FIG. 10, a first diagram 1101 illustrates the resolver output sine signal and resolver output cosine signal and a second diagram 1102 illustrates the angle errors as determined by the estimation circuits 308, 309 as well as the reconstructions (shown hatched).

A third diagram 1103 now illustrates the aggregated reconstruction errors as well as the value of a flag that the anomaly detector 311 sets when it detects an anomaly.

As can be seen, the aggregated reconstruction errors repeatedly exceed the threshold. Therefore, the anomaly detector 311 raises the flag and detects the malfunction. Using the approach of anomaly detection based on aggregated reconstruction errors, the anomaly detector 311 is therefore capable of detecting the malfunction.

The anomaly can be detected because the setting time (from a reconstruction error peak) is prolonged for smaller input signals and therefore the reconstruction error accumulates more strongly during this time than in the nominal case.

It should be noted that both detections may be combined: the anomaly detector 311 may compare individual reconstruction errors with a reconstruction error threshold as well as compare an aggregation of reconstruction errors with an aggregation threshold.

The aggregated reconstruction errors (i.e. sum of reconstruction errors) can be seen as a value derived from all individual reconstruction errors (which fall into the sliding window according to its position at the anomaly detection time).

In the examples described above, the resolver 302 provides, as described above, a carrier signal modulated by (ideally – in particular in case of no malfunction) a sine envelope and a cosine envelope as signals representing positions of the motor over time. However, in other embodiments, a motor sensor may also be used which directly provides a since signal and a cosine signal. In that case, the demodulator 219 is not necessary (or can operate with a constant 1 as carrier signal).

Further, it should be noted that while the above examples have been described with reference to a configuration with two estimation circuits 308, 309 (implementing two estimation paths) operating in parallel, this is not necessary and an anomaly detection approach based on a neural network with autoencoder architecture as described above can also be applied for a motor controller having a single estimation path. Accordingly, the safety circuit 313 does not necessarily include the comparator 310 for comparing the outputs of the two estimation paths.

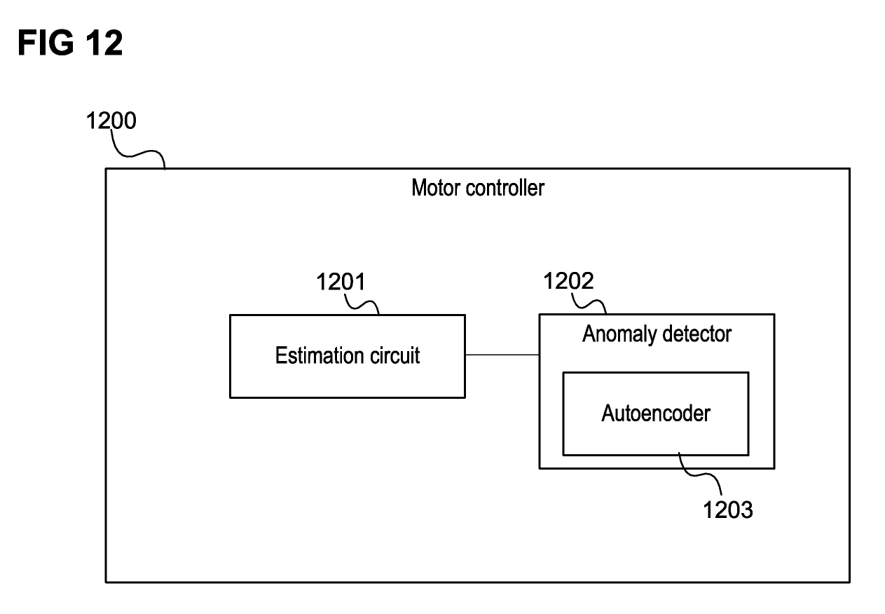

In summary, according to various embodiments, a motor controller is provided as illustrated in FIG. 12.

FIG. 12 shows a motor controller 1200 according to an embodiment.

The motor controller 1200 includes an estimation circuit 1201 configured to perform motor shaft angle estimation using a feedback loop which includes feedback of an angle estimation error signal generated by the estimation circuit.

The motor controller 1200 further includes an anomaly detector 1202 comprising an autoencoder 1203 trained on sections of angle estimation error signals.

The anomaly detector 1202 is configured to supply a section of the angle estimation error signal generated by the estimation circuit 1201 to the autoencoder 1203, determine a reconstruction error of the autoencoder 1203 for the section of the angle estimation error signal and to perform a safety action depending on a value derived from the reconstruction error.

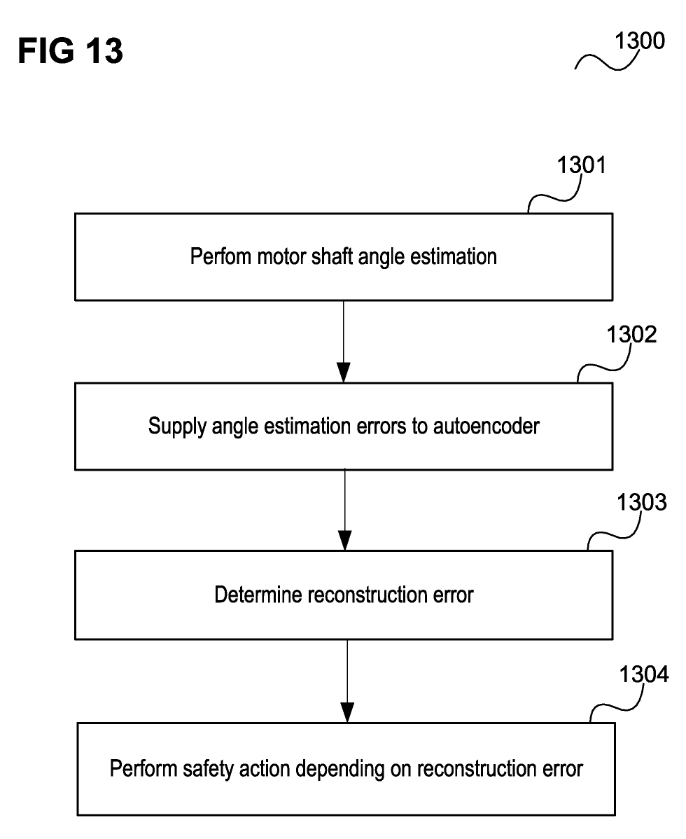

For example, a method as illustrated in FIG. 13 is performed.

FIG. 13 shows a flow diagram 1300 illustrating a method for estimating a motor shaft angle and/or a motor shaft rotation speed of a motor.

In 1301, motor shaft angle estimation using a feedback loop which includes feedback of an angle estimation error signal is performed.

In 1302, a section of the angle estimation error signal is supplied to an autoencoder trained on sections of angle estimation error signals.

In 1303, a reconstruction error of the autoencoder for the section of the angle estimation error signal is determined.

In 1304, a safety action is performed depending on a value derived from the reconstruction error.

According to various embodiments, in other words, detection of anomalies in the operation (and thus in particular a malfunction) of a motor controller (specifically the angle and/or speed estimation part) is performed based on a reconstruction error of an autoencoder when encoding and reconstructing (decoding from the embeddings, i.e. encoding results) an angle estimation error signal.

The safety action may for example be that an alarm is triggered or that the motor is controlled to enter a safe mode, e.g. is stopped.

It should be noted that the components of the motor controller (e.g. the estimation circuit and the anomaly detector or safety circuit) may be implemented and the method may be performed by one or more circuits, where, in an embodiment, a "circuit" may be understood as any kind of a logic implementing entity, which may be special purpose circuitry or a processor executing computer-executable instructions stored in a non-transitory computer-readable medium or memory, firmware, or any combination thereof. Thus, in an embodiment, a "circuit" may be a hard-wired logic circuit or a programmable logic circuit such as a programmable processor, e.g. a microprocessor. A "circuit" may thus be a processor executing software, e.g. any kind of computer program. Any other kind of implementation of the respective functions described herein may also be understood as a "circuit" in accordance with an alternative embodiment.

Various Examples are described in the following:

Example 1 is motor control as described with reference to FIG. 12.

Example 2 is the motor controller of example 1, wherein the safety circuit is configured to trigger the safety action in reaction to the aggregation of the reconstruction errors exceeding a predetermined reconstruction error threshold.

Example 3 is the motor controller of example 1 or 2, wherein the anomaly detector is configured to, for each of a sequence of anomaly detection times, supply a section of the angle estimation error signal generated by the estimation circuit to the autoencoder, determine a reconstruction error of the autoencoder for the section of the angle estimation error signal and to perform a safety action depending on the reconstruction error, wherein the section of the angle estimation error signal includes an angle estimation error generated by the estimation circuit for the angle estimation time and a predetermined number of angle estimation errors generated by the estimation circuit for times preceding the angle estimation time.

Example 4 is the motor controller of example 3, wherein the anomaly detector is configured to aggregate the reconstruction errors determined for multiple of the anomaly detection times to an aggregation of reconstruction errors and perform a safety action depending on the aggregated reconstruction errors.

Example 5 is the motor controller of example 4, wherein the safety circuit is configured to trigger the safety action in reaction to the aggregation of the reconstruction errors exceeding a predetermined aggregation threshold.

Example 6 is the motor controller of any one of examples 1 to 5, wherein the autoencoder is trained to encode angle estimation error signals and reconstruct the encoded angle estimation signals.

Example 7 is the motor controller of any one of examples 1 to 6, wherein the autoencoder is trained to encode angle estimation error signals which the estimation circuit generates for cases without malfunction and reconstruct the encoded angle estimation signals.

Example 8 is the motor controller of any one of examples 1 to 7, wherein the estimation circuit implements a state observer to estimate the motor shaft angle.

Example 9 is the motor controller of any one of examples 1 to 8, wherein the estimation circuit implements a Luenberger observer to estimate the motor shaft angle.

Example 10 is a method as described with reference to FIG. 13.

Example 11 is the method of example 10, comprising training the autoencoder to encode angle estimation error signals and reconstruct the encoded angle estimation signals.

Example 12 is the method of example 10 or 11, comprising training the autoencoder to encode angle estimation error signals which are generated when performing motor shaft angle estimation for cases without malfunction and reconstruct the encoded angle estimation signals.

It should be noted that examples and embodiments described in context with the motor controller are analogously valid for the method for estimating a motor shaft angle and/or a motor shaft rotation speed of a motor and vice versa.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

### REFERENCE SIGNS

100 Motor control arrangement
101 Resolver rotor
102 Resolver
103 Motor
104 Motor rotor
105 Microcontroller
106 Resolver-to-digital converter
107 Carrier signal generator
108 PWM generator
201 Resolver-to-digital converter
202 Filter chain loop
203, 204 ADCs
205 Resolver
206, 207 Mixers
208, 209 Sinc Filters
210 Gain adjuster
211 Carrier signal generator
212 State observer
213 Rotation speed integrator
214 Adder
215 Rotation angle integrator
216 Sine LUT
217 Cosine LUT
218 Subtractor
219 Demodulator
220 Multiplier
221 Adder
222 Multiplier
300 motor control arrangement
301 rotor
302 resolver
303 amplifier
304 carrier generator
305 microcontroller
306, 307 ADCs
308, 309 estimation circuits
310 comparator
311 anomaly detector
312 autoencoder
313 safety circuit
400 Autoencoder
401 Input layer
402 Hidden layer
403 Latent Representation
404 Hidden layer
405 Output layer
501-503 signal diagrams
504 speed changes
505 angle estimation error peaks
601-604 signal diagrams
605 speed change
701-703 signal diagrams
801-803 signal diagrams
901-903 signal diagrams
1001-1003 signal diagrams
1101-1103 signal diagrams
1200 motor controller
1201 estimation circuit
1202 anomaly detector
1203 autoencoder
1300 flow diagram
1301-1304 operations

What is claimed is:

1. A motor controller, comprising:
an estimation circuit configured to perform motor shaft angle estimation using a feedback loop which includes feedback of an angle estimation error signal generated by the estimation circuit;
an anomaly detector comprising an autoencoder trained on sections of angle estimation error signals, wherein the anomaly detector is configured to
supply a section of the angle estimation error signal generated by the estimation circuit to the autoencoder,
determine a reconstruction error of the autoencoder for the section of the angle estimation error signal, and
a safety circuit configured perform a safety action depending on a value derived from the reconstruction error.

2. The motor controller of claim 1, wherein the safety circuit is configured to trigger the safety action in reaction to an aggregation of the reconstruction errors exceeding a predetermined reconstruction error threshold.

3. The motor controller of claim 1, wherein the anomaly detector is configured to, for each of a sequence of anomaly detection times,
supply a section of the angle estimation error signal generated by the estimation circuit to the autoencoder,
determine a reconstruction error of the autoencoder for the section of the angle estimation error signal, and
perform a safety action depending on the reconstruction error,
wherein the section of the angle estimation error signal includes an angle estimation error generated by the estimation circuit for an angle estimation time and a predetermined number of angle estimation errors generated by the estimation circuit for times preceding the angle estimation time.

4. The motor controller of claim 3, wherein the anomaly detector is configured to aggregate the reconstruction errors determined for multiple of the anomaly detection times to an aggregation of reconstruction errors and perform a safety action depending on the aggregated reconstruction errors.

5. The motor controller of claim 4, wherein the safety circuit is configured to trigger the safety action in reaction to the aggregation of the reconstruction errors exceeding a predetermined aggregation threshold.

6. The motor controller of claim 1, wherein the autoencoder is trained to encode angle estimation error signals and reconstruct the encoded angle estimation signals.

7. The motor controller of claim 1, wherein the autoencoder is trained to encode angle estimation error signals which the estimation circuit generates for cases without malfunction and reconstruct the encoded angle estimation signals.

8. The motor controller of claim 1, wherein the estimation circuit implements a state observer to estimate the motor shaft angle.

9. The motor controller of claim 1, wherein the estimation circuit implements a Luenberger observer to estimate the motor shaft angle.

10. A method for estimating a motor shaft angle and/or a motor shaft rotation speed of a motor, comprising:
performing motor shaft angle estimation using a feedback loop which includes feedback of an angle estimation error signal;
supplying a section of the angle estimation error signal to an autoencoder trained on sections of angle estimation error signals;
determining a reconstruction error of the autoencoder for the section of the angle estimation error signal; and
performing a safety action depending on a value derived from the reconstruction error.

11. The method of claim 10, comprising training the autoencoder to encode angle estimation error signals and reconstruct the encoded angle estimation signals.

12. The method of claim 10, comprising training the autoencoder to encode angle estimation error signals which are generated when performing motor shaft angle estimation for cases without malfunction and reconstruct the encoded angle estimation signals.

13. The method of claim 10, wherein the section of the angle estimation error signal includes an angle estimation error for an angle estimation time and a predetermined number of angle estimation errors for times preceding the angle estimation time.

14. The method of claim 10, comprising
aggregating the reconstruction errors; and
performing a safety action depending on the aggregated reconstruction errors.

15. The method of claim 14, comprising triggering the the safety action in response to the aggregation of the reconstruction errors exceeding a predetermined aggregation threshold.

16. A non-transitory computer-readable medium having computer-executable instructions stored thereon that, when executed by a processor, cause the processor to perform operations, the operations comprising:
performing motor shaft angle estimation using a feedback loop which includes feedback of an angle estimation error signal;
supplying a section of the angle estimation error signal to an autoencoder trained on sections of angle estimation error signals;
determining a reconstruction error of the autoencoder for the section of the angle estimation error signal; and
performing a safety action depending on a value derived from the reconstruction error.

17. The non-transitory computer-readable medium of claim 16, wherein the operations comprise training the autoencoder to encode angle estimation error signals and reconstruct the encoded angle estimation signals.

18. The non-transitory computer-readable medium of claim 16, wherein the operations comprise training the autoencoder to encode angle estimation error signals which are generated when performing motor shaft angle estimation for cases without malfunction and reconstruct the encoded angle estimation signals.

19. The non-transitory computer-readable medium of claim 16, wherein the section of the angle estimation error signal includes an angle estimation error for an angle estimation time and a predetermined number of angle estimation errors for times preceding the angle estimation time.

20. The non-transitory computer-readable medium of claim 16, wherein the operations comprise
aggregating the reconstruction errors; and
performing a safety action depending on the aggregated reconstruction errors.
